(19) United States
(12) Patent Application Publication
(10) Pub. No.: US 2017/0157703 A1
(43) Pub. Date: Jun. 8, 2017

(54) DEVICE AND METHOD FOR MONITORING WORK AREA FOR LASER PROCESSING OF MATERIAL

(71) Applicant: Lessmueller Lasertechnik Gmbh, Muenchen (DE)

(72) Inventors: Eckhard Lessmueller, Muenchen (DE); Christian Truckenbrodt, Muenchen (DE)

(21) Appl. No.: 15/365,030

(22) Filed: Nov. 30, 2016

(30) Foreign Application Priority Data
Dec. 2, 2015 (DE) 10 2015 015 651.9

(51) Int. Cl. B23K 26/03; G01S 7/48; G01S 17/88; G01S 17/08

(52) U.S. Cl. CPC B23K 26/03; G01S 17/08; G01S 7/4808; G01S 17/88

(57) ABSTRACT

The invention relates to a monitoring apparatus (10) for a processing system for processing a workpiece (W) by means of a high-energy processing beam (38), in particular in a spatially limited processing area, wherein the monitoring apparatus (10) comprises a measurement beam source (16), which is designed to supply a measurement beam (18) and a recording unit (22), which is designed to detect a component (24) of the measurement beam reflected by the surroundings, wherein the monitoring apparatus (10) is designed to input the measurement beam (18) into a processing beam optics (34) of the processing system, so that the measurement beam (18) and the processing beam (38) can be directed at common positions in the surroundings, wherein the monitoring apparatus (10) is also designed to ascertain at least one distance value (d), which enables a conclusion about a distance from the processing beam optics (34) to the region (X) of the surroundings reflecting measurement beam (18), on the basis of the reflected component (24) of the measurement beam (18) thereby detected, and wherein the monitoring apparatus (10) also detects an evaluation unit, which is designed to evaluate whether the distance value (d) thereby ascertained is within an allowed distance value range (Z).

The invention relates to a monitoring apparatus for a processing system for processing a workpiece by means of a high-energy processing beam, in particular in a spatially limited processing area. The high-energy processing beam is preferably a laser beam and the processing system is a laser processing system for welding or cutting workpieces, for example.

The processing beam of such processing systems constitutes a substantial source of risks in general. For example, extensive damage may be caused in the surroundings of the processing system due to scatter reflections or defective alignments of the processing beam. It is therefore known that so-called safety cells forming an arrangement of safety walls around the processing system may be provided. In other words, the processing area and/or the workroom of the processing system is/are limited spatially in a targeted manner to protect the areas outside of the safety cell from the high-energy processing beam.

To ensure effective protection, however, there are high demands of the properties of the safety walls, in particular in the case of systems with lasers in the multikilowatt range. These must have a high resistance to direct laser bombardment, for example. This means high demands of the materials used and the material thicknesses accordingly, so that there is a substantial increase in cost. The same thing is also true of any rolling gates or other access systems to the safety cells, which should enable delivery of workpieces and outgoing transport. Such access systems must also be reinforced in a complex manner and consequently can be operated only by means of powerful motors.

To improve safety in general and to reduce the demands of such safety cells, it is also known that so-called active safety systems can be provided. These systems monitor the actual alignment of the processing beam and/or its areas of impact within the safety cell. This should ensure that the processing beam is directed only into areas of the safety cell provided for this purpose and in particular does not strike the safety walls directly over a longer period of time.

To this end, there are known sensor devices mounted on safety walls such as, for example, those described in the document DE 20 2007 012 255 U1 which record the impact of a laser beam with the safety walls. It is also known to arrange cameras within the safety cell to detect the actual point of impact of a laser beam within the safety cell. Such an approach is disclosed, for example, in the document WO 2008/019847 A1. The prior art document DE 10 2008 052 570 A1 also discloses a robot-mounted camera, which monitors the alignment of a robot-guided laser welding head. Here again, it should be ensured that the laser beam is directed only into the provided areas of the workspace.

However, it has been found that the known approaches cannot ensure adequately reliable monitoring in all processing situations, and furthermore, they often require complex and cost-intensive equipment measures.

The object of the present invention is therefore to provide a monitoring apparatus of the type disclosed in the introduction, which is inexpensive and permits reliable monitoring.

This object is achieved by a monitoring apparatus comprising a measurement beam source which is designed to supply a measurement beam, and a recording unit, which is designed to detect a portion of the measurement beam that is reflected by the surroundings, wherein the monitoring apparatus is designed to input the measurement beam into a processing beam optics of the processing system, so that the measurement beam and the processing beam can be directed at common positions in the surroundings, wherein the monitoring apparatus is also designed to determine at least one distance value on the basis of the detected reflected portion of the measurement beam, such that this distance value permits an inference regarding a distance of the processing beam optics from the region of the surroundings reflecting the measurement beam, and wherein the monitoring apparatus also comprises an evaluation unit, which is designed to evaluate whether the distance value thus determined is within an allowed distance value range.

The inventors have recognized that the known sensor systems mounted on safety walls are extremely cost-intensive and require complex remodeling measures. Furthermore, these approaches can often detect a critical state of the processing system only when damage has already been done to the safety walls. With the approaches based on cameras distributed in the safety cell, it is always necessary to ensure that the field of view of the camera is not unintentionally concealed. This is associated with great setup and learning efforts accordingly. In the case of robot-mounted camera devices, one can only draw indirectly from the position of the welding head to infer an actual point of impact of the laser beam in the surroundings. It is impossible to detect any errors within the welding head in this way, such as, for example, a faulty deflection of the laser beam into an unintended direction.

The invention provides instead for the actual path of the processing beam to be tracked directly by a measurement beam connected in parallel coaxially at least between the processing beam optics and an impact region in the surroundings. Therefore the actual beam length and/or the distance from the processing beam optics to an impact region in the surroundings can preferably be monitored continuously. It is thus possible to ascertain whether the measurement beam and consequently also the processing beam strikes a workpiece disposed comparatively close to the processing beam optics or whether an impact occurs only at a greater distance, for example, on a safety wall which is typically a greater distance away.

The measurement beam source may be designed to generate and emit light and/or laser radiation of a suitable wavelength. In a broader sense, the measurement beam source may also be designed in the form of an interface for connection of an optical fiber or may include such an interface to input a measurement beam generated externally.

The measurement beam may be emitted continuously, as a single beam pulse or as a beam pulse sequence as well as being optically modulated in a known manner. Furthermore, it is self-evident that the measurement beam can also be input into the processing beam optics independently of current generation of the processing beam. Thus it may be provided according to the invention that the measurement beam enters the processing beam optics without parallel creation of the processing beam and is directed by the processing beam optics at certain areas of the surroundings. In this way, the expected impact region of the processing beam can be detected in advance. Alternatively or in addition, however, parallel generation and alignment of the measurement beam and the processing beam may also be provided.

The recording unit may be any suitable unit, with which, for example, a time of impact of the reflected measurement beam component on the recording unit can be detected and/or an impact intensity as well as additional beam properties of the reflected measurement beam can be detected. The measurement beam source and the recording unit may be components of an optical distance measuring unit of the monitoring apparatus.

For input of the measurement beam into the processing beam optics and into a processing beam that is optionally generated at the same time, the monitoring apparatus may be designed with an optical interface region through which the measurement beam can enter the processing beam optics and the reflected measurement beam component can preferably also emerge again. The input and/or output of the measurement beam preferably take(s) place coaxially in the processing beam. In principle the input into the processing beam optics (and/or the output from same) may also be achieved by input of the measurement beam into the processing beam at any other location within the processing system and entering the processing beam optics together with the latter. For example, the input and/or output of the measurement beam and processing beam may take place directly within a processing beam source of the processing system whereupon the mutually input beams are guided by means of an optical fiber to the processing beam optics.

Furthermore, according to the invention, it is also possible to provide that the monitoring apparatus is designed as a separate module which is easily upgradable on an existing processing system and in particular a laser welding head. In this context, the monitoring apparatus and the welding head may each have optical interface regions that can be coupled to one another and permit the input of the measurement beam into the processing beam optics (and/or output from same) as described above.

The distance value that has been determined may be a time specification, which relates to the duration of the emission of the measurement beam until detection of the reflected measurement beam component. With knowledge of the design of the monitoring apparatus and the processing beam optics as well as in particular the distances traveled by the measurement beam therein, it is also possible to determine the period of time between emergence from the processing beam optics and an impact in the surroundings. It is likewise possible to determine the distance as a concrete distance value in the sense of a length specification. This may take place on the basis of the time duration measured values mentioned above.

The evaluation unit may be provided in the form of known computing units and/or electronic analyzers. If the monitoring apparatus is designed as a separately handleable module that can be upgraded on existing processing systems, then the evaluation unit preferably forms a component of this module. Likewise, however, it is also possible to provide that the evaluation unit is set up externally and communicates with the additional components of the monitoring apparatus via corresponding communication links. The evaluation unit may also be designed to determine the value or at least the amount of any deviation of the determined distance value from the allowed distance value range.

As explained in detail below, the allowed distance value range may contain in general a fixed or variable allowed upper limit and/or lower limit. Furthermore, the distance value range may contain in general any number of values, for example, even just one single value in the form of an upper limit.

The distance value range may define a virtual allowed workspace so to speak around the processing beam optics based on the definition of the upper limit and/or lower limit, wherein the only impact regions and/or reflection regions of the measurement beam in the surroundings that are recognized as allowed are those within this workspace. However, if the measurement beam is reflected by a surroundings area at a greater distance such as, for example, a safety wall, then the evaluation unit determines that the current distance value is located outside of the allowed distance value range.

It is thus possible to monitor, preferably continuously, whether the processing beam strikes the surroundings only at predetermined intervals from the processing beam optics and thus always maintains an adequate distance from the safety walls of any safety cell. As described below, this also permits a reliable review of whether a workpiece is in fact opposite the processing beam optics prior to the start of processing.

A refinement of the invention provides that the distance value is determined based on a transit time measurement of the measurement beam, in particular wherein the transit time measurement takes place by means of time-of-flight measurement unit, comprising the measurement beam source and the recording unit. The transmit time measurement may include the period of time between emission of the measurement beam (for example, in the form of a single beam pulse) and detection of the reflected measurement beam component by means of the recording unit. As described above, with knowledge of the relevant dimensions of the monitoring apparatus and/or the processing beam optics and in particular the distances traveled by the measurement beam based on this, the desired distance value between the processing beam optics and the surroundings can also be determined.

According to the invention, it is also possible to provide for the measurement beam source to include a laser diode and/or an LED. This permits a particularly precise definition and emission of the measurement beam and in particular individual measurement beam pulses.

It is likewise possible to provide that the recording unit includes a photodiode. This permits a rapid and precise detection of the reflected measurement beam component by means of a sensor system having a comparatively simple design. Alternatively or additionally, the recording unit may include an image sensor.

In one refinement of the invention it is provided that the monitoring apparatus is designed to influence the operation of the processing system in accordance with the evaluation result determined by the evaluation unit. The monitoring apparatus may therefore be designed to generate or alter control signals which influence the operation of the processing system in the desired manner.

Such an influence on operation may be provided in particular when the evaluation result determined by the evaluation unit reveals that a distance value determined currently is not within the allowed distance value range. As explained above, this indicates that the measurement bean and thus a processing beam optionally generated in parallel strikes an object at an unwanted distance from the processing beam optics in surroundings. According to the present refinement of the invention, the monitoring apparatus may initiate suitable countermeasures in such a case and may in particular intervene directly in the operation of the processing system. This may also be made dependent on whether a certain result of the evaluation unit such as, for example, failure to maintain the allowed distance value range, is above a certain minimum duration or a minimum number of individual measurement operations.

In this context, it is also possible to provide that the monitoring apparatus is equipped to output a warning signal and/or to cause the processing system to output a warning signal. The warning signal may be an internal control signal, which is recognized and analyzed accordingly by a controller of the processing system.

Likewise, it may be an externally perceptible warning signal, for example, an acoustic or optical warning signal which is easily perceptible for the operating personnel of the processing system.

Furthermore, it is also possible to provide according to the invention that the monitoring apparatus is equipped in accordance with the evaluation result determined by the evaluation unit to restrict or suppress operation of the processing system. Accordingly, the monitoring apparatus may be equipped to influence the operating parameters of the processing system and in particular to influence the generation of the processing beam as well as its alignment and/or intensity in accordance with the evaluation result thereby ascertained. In other words if the allowed distance value range is not maintained, the monitoring apparatus may cause the generation of the processing beam to be suppressed at least temporarily or the power of a processing beam source to be limited.

As described above, the monitoring apparatus may be designed in particular to carry out an evaluation of the determined distance value even before the generation of the processing beam. In this way, for example, the presence of a workpiece opposite the processing beam optics can be detected in this way. In this case the allowed distance value range may define an allowed workspace between the processing beam optics and the workpiece surface and it may be defined preferably on the basis of a known form and/or material thickness of the workpiece as well as its arrangement in space (for example, when the workpiece is clamped on a processing table at a known height). If the determined distance value exceeds the allowed distance value range, this indicates that reflection by the surroundings takes place unexpectedly late. This permits the conclusion that a corresponding workpiece is not present. In this case generation of a processing beam can be prevented by the monitoring apparatus in order to prevent unwanted damage to the processing table, for example.

Furthermore, it is also possible to provide in this context that the monitoring apparatus is equipped to interrupt a power supply to the processing system. To do so, the monitoring apparatus may include fuses, relays or comparable switching devices which interact with the power supply to the processing system. Alternatively, the monitoring apparatus may be designed or equipped separated from such switching devices to access them via communication links and actuate them by means of corresponding control signals.

The power supply can interact in general with all or just the selected components of the processing system. For example, it may be the power supply for a processing beam source of the processing system. Furthermore, it is possible to provide that the monitoring apparatus supplies a preferably two-channel enable signal which closes the power supply of the processing system only when the evaluation result by the evaluation unit is positive and thus enables the creation of the processing beam. As soon as the evaluation unit ascertains that the distance value is outside of the allowed distance value range, the enable signal is omitted and the power supply is interrupted. This prevents further generation of the processing beam.

A refinement of the invention provides that the monitoring apparatus is set up in accordance with the evaluation result ascertained by the evaluation unit to generate control signals for regulating the processing beam and in particular for regulating the focal position of the processing beam. The term “control signal” can be understood to be any signal or any information thereby imparted, which can be used in the context of a corresponding control, for example, an instantaneous deviation from the allowed distance value range. Furthermore, the parameters of the processing beam that can be regulated in particular are those which are to be adapted as a function of the distance value thereby ascertained in order to achieve an advantageous work result or to ensure an adequate certainty. This relates, for example, to the position, the alignment or the guidance rate of the processing beam relative to the workpiece.

By means of the regulation of a focal position of a processing beam, it is possible to ensure that the focal point of the processing beam is always situated on a component surface to be machined. This is advantageous in particular in processing irregular components. The allowed distance value range may in this case be defined as the desired distance from the processing beam optics to the opposing areas of the component surface plus any tolerance range. The allowed distance value range thus defines a virtual workspace which is preferably extremely narrow, i.e., slender and which extends along the component surface and preferably includes the component. If the distance value thereby ascertained does not fall within this narrow allowed distance value range, this indicates that the processing beam optics is disposed at an undesirable distance from the component surface. Readjustment of the focal position may then be necessary to balance out the deviation ascertained. To this end, the monitoring apparatus can generate corresponding correction signals, in particular based on the distance value actually ascertained.

In a refinement of the invention, the allowed distance value range is defined as a function of a prevailing processing situation and/or can be ascertained as a function of a prevailing processing situation by the revision apparatus. In other words, it is possible to provide that the allowed distance value range can be adapted to the prevailing processing situation in a flexible manner.

For example, the processing system may comprise a positioning system such as preferably an industrial robot in order to be able to move and arrange the processing beam optics in a flexible manner in space. With knowledge of prevailing axial positions of the positioning system it is thus possible for a position of the processing beam optics to be defined and/or ascertained in a flexible manner in space and thus for an adequate allowed distance value range. To do so it is also possible to access additional information with respect to the surroundings of the processing system in order to take into account a prevailing distance of the processing beam optics from the safety walls of any safety cell, for example. The shorter this distance turns out to be, the lower the selected prevailing upper limit of the allowed distance value range may be in order to prevent a long-lasting impact of the processing beam with the safety walls.

As explained below, the processing beam optics may also comprise a deflecting apparatus to align the measurement beam and the processing beam with common ambient regions. In this case, a prevailing axial position of the deflecting apparatus in the sense of a prevailing processing situation may be taken into account and the allowed distance value range can be adapted flexibly to it accordingly. For example, for comparatively large deflection positions, in which the measurement and processing beams emerge from the processing beam optics at large angles accordingly, greater distance values are then defined than those otherwise allowed at comparatively low deflection positions. This permits a definition of rectangular virtual workspaces about the processing beam optics as well as any other shapes.

Finally, according to this refinement, it is also possible to provide that the allowed distance value range is selected as a function of prevailing processing phases of the workpiece. As described above, for example, in an advance inspection with regard to the presence of a workpiece, a narrow allowed distance value range may be selected whereas in continuous processing operation the allowed distance value range is increased in order to increase the fault tolerance.

The currently allowed distance value ranges can also be detected in the learning mode by having the processing system travel on a processing path along the workpiece without generating a processing beam. The monitoring apparatus can then ascertain the prevailing distance values for individual processing positions or for all processing positions continuously. The distance values thereby ascertained plus any tolerance ranges can then be saved as the allowed distance value ranges for the respective processing positions.

As already mentioned, it may also be provided according to the invention that the processing beam optics comprises at least one common deflecting device by means of which the measurement beam and the processing beam can be directed at the same positions in the surroundings. The deflecting device may be designed as a scanner mirror, which is preferably adjustable by at least two axes in a known way. In this way, it is possible to accurately define the alignment of the processing beam and the measurement beam and/or the angles at which the corresponding beams emerge from the processing beam optics. By deflection by means of a common deflecting device, it is also ensured that the information obtained on the basis of the measurement beam permits the most accurate possible inferences regarding the processing beam because an essentially identical beam path can be achieved between the processing beam optics and the surroundings.

In this context, it is also possible to provide that the distance value ascertained by the monitoring apparatus relates to the distance between the common deflecting device and the reflected area of the surroundings.

According to a refinement of the invention, the evaluation unit is designed to detect the fact that the distance value has exceeded and/or fallen below the allowed distance value range.

Thus the allowed distance value range may comprise not only an upper limit but also a lower limit in addition. If the distance value falls below this lower limit, this indicates that the measurement beam was reflected too soon and therefore was reflected from an area that is not provided. This may be the case in particular if the processing beam optics is defective and assumes a deflection position that is not provided. In these cases, the measurement beam can be reflected from internal regions of the welding head, which are positioned much closer to the processing beam optics or even from a direct component of same in comparison with the impact regions in the surroundings actually provided. An unexpectedly short distance value may also occur when any common deflection device is damaged and the measurement beam is allowed to pass through instead of being guided out of the processing system. It is self-evident that the monitoring apparatus can also initiate one of the safety functions and/or countermeasures described above even when short distance values occur accordingly, and this can then suppress the generation of the processing beam, for example.

According to a refinement of the invention, the evaluation unit is designed to recognize a malfunction with respect to ascertaining the distance value. This may take place in general by carrying out a plausibility check of the distance value ascertained. In particular the evaluation unit may be equipped to detect a failure of the measurement beam component reflected by the surroundings to occur and/or determination of multiple distance values for one and the same measurement operation as corresponding malfunctions.

In the case of omission or failure of the measurement beam component reflected by the surroundings to occur, the distance value ascertained may be zero or may be infinite, for example. Likewise, a predetermined error value may be indicated because an analyzable measurement signal could not be recorded and the distance value therefore could not be ascertained. This may be recognized by the evaluation unit as a corresponding malfunction.

A plurality of distance values may occur, for example, when the reflected measurement beam component includes multiple individual signals and/or reflection components because of back reflections due to optical elements of the processing beam optics and thus a corresponding plurality of distance values is ascertained for one and the same measurement operation. This can also be recognized as a malfunction by the evaluation unit.

If a corresponding plurality of distance values is detected, the evaluation unit may also be designed to determine, on the basis of additional plausibility considerations and/or intensity comparisons, the distance value that is presumably to be assigned to the actual impact point in the surroundings. This value can then be used as the basis for further evaluation by the evaluation unit. For example, it is possible to provide that only the largest distance value by amount is to be used for the further evaluation.

The evaluation unit may also be designed to carry out the evaluation of whether the distance value thereby ascertain is within the allowed distance value ranges, taking into account the detection of a malfunction. For example, the evaluation unit can determine directly on recognition of a corresponding malfunction that there is currently no distance value within the allowed distance value range. Likewise, it is possible to provide that a more accurate evaluation of the distance value is carried out only when it has been recognized that there is no malfunction.

As a result, it is possible to ensure through this refinement that defective measurement processes are recognized and taken into account accordingly. In particular in detection of a malfunction, any of the safety functions and/or countermeasures discussed above may be initiated such as, for example, shutting down the processing system or restricting and/or suppressing its operation.

The invention also relates to a processing system for processing a workpiece by means of a high-energy processing beam comprising a monitoring apparatus according to any one of the aspects discussed above.

Likewise, the invention relates to a method for monitoring a processing system for processing a workpiece by means of a high-energy processing beam, in particular with a monitoring apparatus according to any one of the aspects discussed above, comprising the steps:
Supplying a measurement beam;
Input of the measurement beam into a processing beam optics of the processing system;
Controlling the processing beam optics of the processing system to direct the measurement beam at a position in the surroundings;
Detecting a portion of the measurement beam reflected by the surroundings;
Ascertaining at least one distance value on the basis of the detected reflected component of the measurement beam, wherein the distance value permits an inference about the distance of the processing beam optics from the area of the surroundings reflecting the measurement beam; and
Evaluating whether the distance value thereby ascertained is within an allowed distance value range.

It is self-evident that this method may also include additional steps to achieve the effects described above on the example of the inventive monitoring apparatus and to provide functions. It is possible in particular to provide that, in addition to supplying the measurement beam, a processing beam is also supplied to enable a parallel distance value monitoring in ongoing processing mode. Furthermore, the process may include the step of ascertaining the distance value based on a transit time measurement of the measurement beam, in particular with the assistance of a time-of-flight measurement unit as well as using corresponding laser diodes, LEDs and/or photodiodes. Likewise, the method may include additional steps depending on the result of the evaluation in order to initiate the safety functions and countermeasures mentioned above when there is a deviation in the distance value ascertained from the allowed distance value range. In such a case, the step of restricting or suppressing operation of the processing system may be provided in addition, for example, by suppressing the power supply to the processing system.

The invention is explained in greater detail below as an example on the basis of the accompanying figures where similar elements or those having the same effect are in general labeled with the same reference numerals in the various embodiments shown here.

In the drawings:

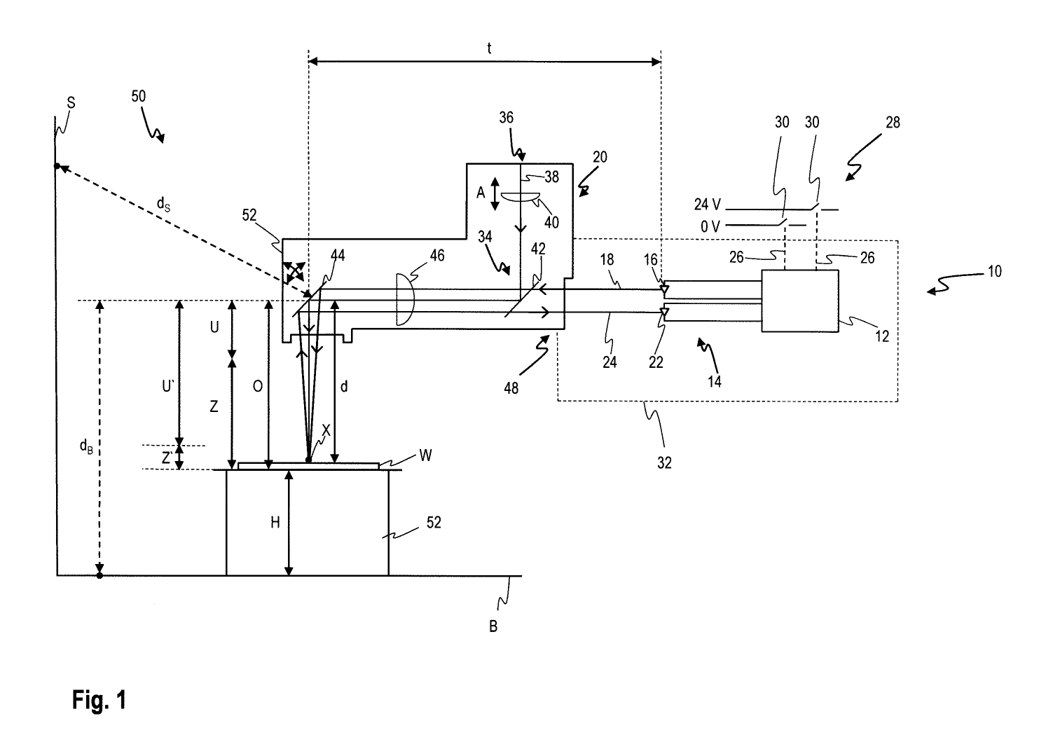

FIG. 1 shows a schematic diagram of a laser welding head with a monitoring apparatus coupled to it according to a first exemplary embodiment of the invention;

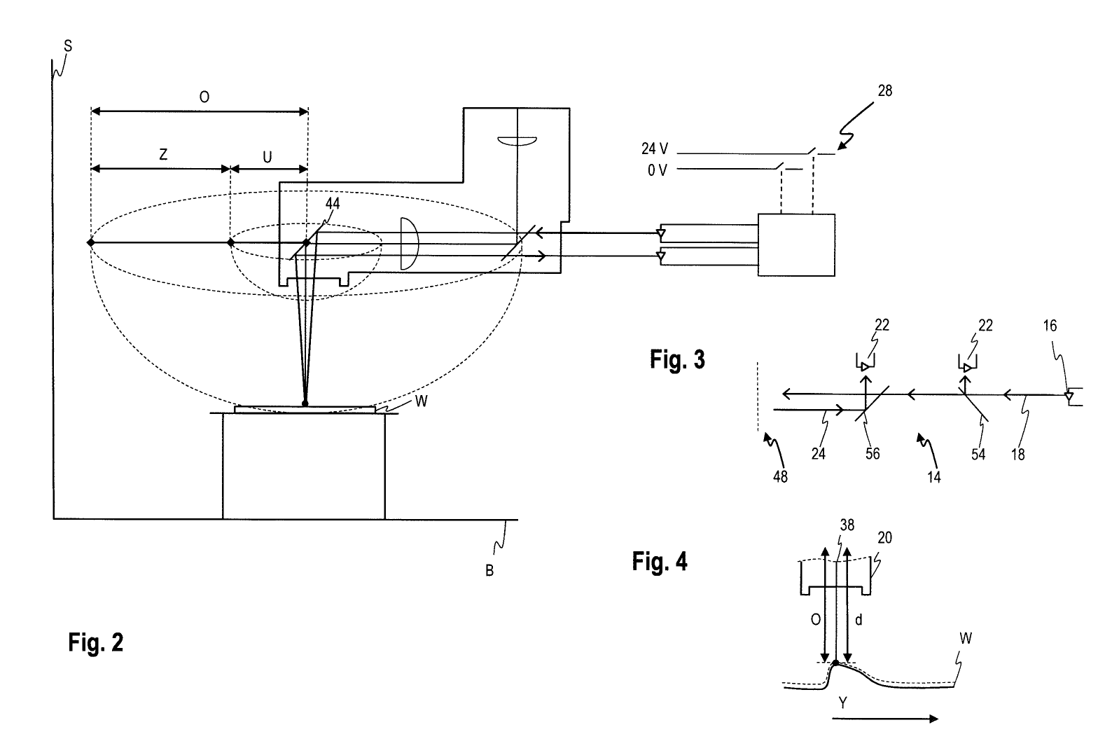

FIG. 2 shows a schematic diagram of the virtual workspaces defined by the monitoring apparatus from FIG. 1;

FIG. 3 shows a partial diagram of a measurement unit for a monitoring apparatus according to another exemplary embodiment of the invention; and

FIG. 4 shows a schematic diagram to illustrate how the processing beam is regulated according to the invention.

FIG. 1 shows a monitoring apparatus according to the invention, labeled as 10 in general. The monitoring apparatus 10 comprises a computing unit 12 which includes an evaluation unit (not shown separately). The computing unit 12 is connected to a measurement unit 14 which in the present case is designed as an optical distance measuring unit in the form of a time-of-flight sensor array. In detail, the measurement unit 14 comprises a measurement beam source in the form of a laser diode 16 which emits a measurement beam pulse 18 in the direction of a laser welding head 20. Furthermore, the measurement unit 14 comprises a recording unit in the form of a photodiode 22 with which a measurement beam component 24 that is reflected by the surroundings can be detected.

It can also be seen that the computing unit 12 is connected to a power supply 28 of a laser processing system (not shown separately) by means of communication links 26 (shown with dotted lines). More specifically, the computing unit 12 can access two relay units 30 via the communication links 26, each relay unit being assigned to different voltage levels of the power supply 28.

The monitoring apparatus 10, as indicated by the dotted housing 32, is designed as a module that can be handled separately and is mounted on the laser welding head 20. The laser welding head 20 is disposed on a bent arm robot (not shown) to be able to be disposed and moved in space.

As shown in FIG. 1, the laser processing system, which is not shown separately, together with the laser welding head 20 and the monitoring apparatus 10 mounted thereon are disposed in a safety cell 50, which is indicated schematically here. This defines a spatially limited processing area around the laser processing system. The safety cell 50 therefore has bottom areas and safety wall areas B, S surrounding the laser processing system and shielding it from the remaining factory surroundings. FIG. 1 shows as an example only one single lateral safety wall area S. Furthermore, a workpiece W, which is clamped on a processing table 52 and is spaced a distance away from the bottom area B by a predetermined height H, is disposed in the safety cell 50.

In detail, the laser welding head 20 comprises processing beam optics 34, having at the input end an interface 36, which is embodied as an optical fiber and enables the input of a laser beam 38 from a laser beam source that is not shown in greater detail here. Starting from the interface 36, the laser beam 38 first passes through a collimation lens 40 that can be displaced along an axis A and thus along the axis of the laser beam. Next the laser beam 38 strikes a beam splitter 42, which deflects the laser beam 38 to a biaxial diffracting device in the form of a processing scatter 44 when it passes through a focusing lens 46. The laser beam 38 is directed at the desired area of the surroundings by means of the processing scanner 44 and in this case is directed at the workpiece W.

Furthermore, it can be seen in FIG. 1 that the measurement beam pulse 18 emitted by the monitoring apparatus 10 enters the laser welding head 20 via an optical interface area 48 and enters the processing beam optics 34. In doing so, the beam pulse passes first through the beam splitter 42, which is designed to allow the wavelength ranges of the measurement beam 18 to pass through, and then after passing through the focusing lens 46, it strikes the processing scatter 44. The measurement beam pulse 18 is input coaxially into the laser beam 38 and is directed jointly with the latter into the surroundings via the processing scatter 44.

However, as indicated by corresponding arrows in FIG. 1, the measurement beam component 24 reflected by the surroundings passes through the processing beam optics 34 in the opposite direction. In doing so, starting from the workpiece W, it first strikes the processing scanner 44, then enters the monitoring apparatus 10 after passing through the focusing lens 46 and beam splitter 42, by way of the optical interface 48, striking the photodiode 22 there. The photodiode 22 detects the time of impact of the reflected measurement beam component 24 after emission of a prior measurement beam pulse 18.

Thus, as a result, a measurement beam pulse 18 emitted by the laser diode 16 is input into the processing optics 34 and directed via the processing scanner 44 at a position in the surroundings and/or within the safety cell 50. In the case shown here, the laser beam 38 and the measurement beam pulse 18 are generated at the same time and directed at a common point of impact X of the workpiece W. Starting from this point of impact X, a corresponding measurement beam component 24 is reflected and returned back to the measurement unit 14 of the monitoring apparatus 10 in the manner described above.

It is self-evident in general that the beam paths shown in FIG. 1 serve only the purpose of illustration and do not reflect the actual physical paths. As already mentioned, the measurement beam pulse 18 is input coaxially into the laser beam 38, so that the path and the distances traveled by these beams as well as the reflected measurement beam component 24 between the processing scanner 44 and the workpiece W can be assumed to be identical with sufficient accuracy.

Based on the design described above, the computing unit 12 of the monitoring apparatus 10 can perform a transit time measurement and determine the period of time elapsing between the emission of the measurement beam pulse 18 and striking the photodiode 22. Therefore, the point in time of the emission of the measurement beam pulse 18 and the point in time of the reflected measurement beam component 24 striking the photodiode 22 are recorded, and the difference between these values is determined.

Based on this transit time measurement, the computing unit 12 also determines a prevailing distance value d between the processing scanner 44 and the reflective region X. To this end, the distance t between the laser diode and photodiodes 16, 22 and the processing scanner 44, the distance being fixed in general is taken into account for this purpose. The distance t defines the constant period of time required by the measurement beam pulse and the reflected measurement beam component 24 for passing through the processing beam optics 34 and the monitoring apparatus 10. The remaining period of time component (and/or half of that) indicates the period of time accordingly required by the measurement beam pulse 18 to go from the processing scanner 44 to the point of impact X. In the same sense, this corresponds to the period of time component required by the reflected measurement beam component 24 to go form the point of impact X to the processing scanner 44. A distance value d in the sense of a concrete distance value, which is given in centimeters, for example, can be calculated from this remaining period of time component in a known manner. This distance value d thus indicates the currently prevailing distance between the processing scanner 44 and the point of impact X.

As described below, the distance value d from the evaluation unit of the computing unit 12 which is thus determined in this way is compared with an allowed distance value range Z in order to ensure that the laser beam 38 strikes only points of impact X actually provided within the safety cell 50. In the case shown here, an upper limit O of the allowed distance value range Z is such that the region of the workpiece W to be processed lies within the allowed distance value range Z. However, any points of impact close to the safety wall S or the bottom area B would be a much greater distance from the processing scanner 44, so that their distance values d would exceed the upper limit O. as an example, two corresponding distance values d_{S} and d_{B} are shown here for an intended impact with the safety wall S and the bottom B.

Furthermore, FIG. 1 shows a lower limit U of the allowed distance value range Z which stipulates a minimum value for the distance values d. If the value drops below the lower limit U, this signals that there are defects within the welding head 20 and therefore the distance value d thereby ascertained will turn out to be unexpectedly short. For example, the error scenario, wherein the processing scanner 44 has aligned the measurement beam pulse 18 incorrectly and this beam pulse is reflected by the housing of the laser welding head 20 or by additional components of the processing beam optics 24 and returned directly to the monitoring apparatus 10, can be taken into account. Likewise, the case when the processing scanner 44 can be damaged, and the measurement beam pulse 18 passes through it in a straight line, so that it is reflected by the rear wall 52 of the laser welding head 20 instead of the workpiece W.

It can be seen that the lower limit in FIG. 1 has a comparatively low value. This value can thus drop below the lower limit U only through regions in the immediate proximity of the processing scanner 44.

As shown in FIG. 1, the allowed distance value range Z is thus defined by the value range between the lower limit U and the upper limit O. In other words, the evaluation unit evaluates as allowed all the distance values d, but these distance values have greater values than the lower limit U but lower values than the upper limit O. The distance value d determined for the point of impact X shown here is thus admissibly within the distance value range Z.

As a result, a prevailing distance value d is thus ascertained by the computing unit 12 for each measurement beam pulse 18 ascertained by the method described above and is then recognized by the evaluation unit as being allowed only if it is within the allowed distance value range Z. If this is the case, the computing unit 12 delivers a control signal to the relay devices 30 of the power supply 28 via the communication lines 26 in order to close the power supply. In this state, the laser processing system (not shown separately) can generate the laser beam 38 and can carry out a workpiece processing.

However, if it is recognized that a currently ascertained distance value d is outside of the allowed distance value range Z, then no control signal is emitted to the relay devices 30. These thus automatically assume an open position so that the power supply 28 is interrupted and generation of the laser beam 38 is suppressed.

With the monitoring apparatus 10 shown here, the upper limit O and the lower limit U can be adapted to prevailing processing situations in a flexible manner. Thus before beginning the actual workpiece processing, the presence of a workpiece W on the processing table 52 should be verified first. To do so, a one-time test of the distance value d by the evaluation unit should be sufficient in principle because the upper limit O in the case shown here ends at the table surface. Exceeding the upper limit O thus reveals an unexpectedly late reflection and therefore an absence of the workpiece W.

To increase the relevance of the results, in the present case it is additionally provided that the initial lower limit U′ is to be formulated with a much higher value than in the ongoing processing operation (cf. lower limit U for processing operation in FIG. 1). In other words, the initial lower limit U′ is moved much closer to the upper limit O, which remains the same in the case shown here, so that the distance value range Z′, which is initially allowed, is reduced accordingly. In this way, the allowed distance value range Z′ and thus the tolerance range for the distance value d is reduced initially in a targeted manner to be able to draw an accurate conclusion regarding the presence of the workpiece W. This means that the probability that a distance value d, which is evaluated as allowed, can in fact be attributed to a reflection by the workpiece W in the case of the initially reduced distance value range Z′, this is much higher than with the greater distance value range Z for the continuous processing operation.

For continuous processing operation, however, retaining such a narrow allowed distance value range Z′ would entail an increased risk of unintended interruptions and frequent error messages. Thus, the substantially greater distance value range Z is used instead of the former.

In FIG. 1, the point of impact X also lies in the initially allowed distance value range Z′ so that the evaluation unit of the computing unit 12 ascertains an allowed evaluation result and, by closing the current circuit 28, generation of the laser beam 38 is thus made possible. As soon as the processing is begun by supplying the laser beam 38, the allowed distance value Z is increased to increase the error tolerance.

In the diagram according to FIG. 1, the upper limit O and lower limit U for the continuous processing mode are selected to be equal for each deflection position of the processing scanner 44. Thus the lower limit U and the upper limit O each theoretically define at least one spherical virtual workspace around the processing scanner 44. The workspace that is actually relevant turns out to be much lower due to the construction of the welding head 20 and the possible deflection positions of the processing scanner 44. In FIG. 2, the virtual workspaces defined by the upper limit O and the lower limit U are therefore shown in simplified terms and hemispheres in FIG. 2. The allowed distance value range Z thus defines a virtual workspace in the form of a hemispherical shell around the processing scanner 44. As already described, all the points of impact X situated within this hemispheric shell and the distance values d associated with them are evaluated as allowed by the evaluation unit.

Furthermore, FIG. 2 shows again that any safety critical points of impact on the safety wall area S or the bottom area B lie outside of the allowed virtual workspace Z and thus would trigger an immediate interruption in the power supply 28. Therefore, the requirements of the safety walls S are reduced because the risk of long-term laser bombardment is greatly reduced.

It is self-evident that the shapes and sizes of the virtual workspaces defined by the upper limit O and the lower limit U are merely examples. According to the invention, for example, it is equally possible to provide for the limits O, U to be defined as a function of the actual deflection positions of the processing scanner 44. Likewise, the lower limit U may be omitted entirely so that the allowed distance value range would extend from zero up to the upper limit O. With reference to FIG. 2 it is thus equally possible to provide for the upper limit O to be defined so that it is much larger and therefore the workpiece W in any case will lie completely within the allowed distance value range Z.

FIG. 3 shows an alternative time-of-flight sensor array for the measurement unit 14 of the monitoring apparatus 10 from FIG. 1. This again shows a laser diode 16 emitting a measurement beam pulse 18 which passes through a first partially transmissive beam splitter 54, wherein a defined component of the measurement beam light is deflected in the direction of a first photodiode 22. Next the measurement beam pulse 18 processed through a second beam splitter 56 to then enter into the processing beam optics 34 (not shown separately) through an optical interface region 48 which is indicated only schematically, in the manner described above.

In a method similar to that described above, a reflective measurement beam component 24 is returned back to the measurement unit 14 via the optical interface region 48 and strikes the second beam splitter 56 there. The reflected measurement beam component 24 is then deflected in the direction of a second photodiode 22.

A transit time measurement of the measurement beam pulse 18 can also be performed by means of this sensor array to monitor whether an allowed distance value range Z is maintained. To do so the first photodiode 22 detects a starting time at which the emission of the measurement beam pulse 18 is recorded for the first time whereas the second photodiode 22 detects the time of impact of the reflected measurement beam component 24 after successful reflection into the surroundings. The difference in the times thereby detected is the transit time of the measurement beam pulse 18 to and from the reflective area of the surroundings and can be converted back into a corresponding distance value d.

FIG. 4 shows a simplified basic diagram of workpiece processing by means of the apparatus described with reference to FIG. 1 in order to explain regulation of the focal position of the laser beam 38 using the monitoring apparatus 10 according to the invention. One can again see the laser welding head 20, which is indicated schematically, disposed opposite an uneven workpiece W. The position of the focal point is to be regulated in a known way so that it is always positioned as accurately as possible on the surface of the workpiece W. Accordingly, the upper limit O of the allowed distance value range Z is selected so that it essentially coincides with the workpiece surface. The computing unit 12 of the monitoring apparatus 10 accesses the processing information available in the processing system to continuously adapt the upper limit O to the prevailing processing situation. For example, the computer system may access information with respect to a current axial position of a bent arm robot carrying the laser welding head 20 as well as the shape of the workpiece W and its arrangement within the safety cell 50. In movement of the laser welding head 20 along the workpiece surface in the direction Y as indicated, the upper limit O is thus adapted continuously in such a way that it forms the virtual workspace indicated with dotted lines along the workpiece surface.

In the case shown here, there will not be any additional definition of a lower limit U. The allowed value range thus contains only the value of the upper limit O. However, it is equally possible to provide that a lower limit U is provided for taking into account tolerances, wherein the lower limit U approaches the upper limit O accordingly.

As a result, the evaluation unit of the computing unit 12 thus recognizes as allowed only such distance value d that coincide with the upper limit O currently selected. If the distance value d thus determined differs from the upper limit O, the computing unit 12 outputs a control signal via communication link (not shown separately) to the laser processing system to order regulation of the focal position of the processing beam 38 in a known way.

To this end, the computing unit 12 may also be designed to ascertain whether the distance value d thereby ascertained exceeds or falls below the upper limit O and/or the size of the corresponding deviation. This information can also be taken into account in generating the corresponding control signal.

1. A monitoring apparatus for a processing system for processing a workpiece (W) by means of a high-energy processing beam, in particular in a spatially limited processing area,
wherein the monitoring apparatus comprises a measurement beam source which is designed to supply a measurement beam and a recording unit which is designed to detect a component of the measurement beam reflected by the surroundings,
wherein the monitoring apparatus is designed to input the measurement beam into a processing beam optics of the processing system so that the measurement beam and the processing beam can be directed at common positions in the surroundings,
wherein the monitoring apparatus is also designed to ascertain at least one distance value (d), which enables a conclusion about a distance from the processing beam optics to the region (X) of the surroundings reflecting the measurement beam, on the basis of the reflected component of the measurement beam thereby detected,
and wherein the monitoring apparatus also detects an evaluation unit, which is designed to evaluate whether the distance value (d) thereby ascertained is within an allowed distance value range (Z).

2. The monitoring apparatus according to claim 1, wherein the distance value (d) is ascertained on the basis of a transit time measurement of the measurement beam, in particular wherein the transit time measurement is performed by means of a time-of-flight measurement unit, which includes the measurement beam source and the recording unit.

3. The monitoring apparatus according to claim 1, wherein the measurement beam source (16) includes a laser diode and/or an LED.

4. The monitoring apparatus according to claim 1, wherein the recording unit includes a further diode.

5. The monitoring apparatus according to claim 1, wherein the monitoring apparatus is designed to influence the operation of the processing system in accordance with the evaluation results ascertained by the evaluation unit.

6. The monitoring apparatus according to claim 5, wherein the monitoring apparatus is equipped to output a warning signal and/or to command the processing system to output a warning signal.

7. The monitoring apparatus according to claim 5, wherein the monitoring apparatus is equipped to restrict or suppress the operation of the processing system.

8. The monitoring apparatus according to claim 7, wherein the monitoring apparatus is equipped to interrupt a power supply of the processing system.

9. The monitoring apparatus according to claim 5, wherein the monitoring apparatus is equipped to generate control signals for regulating the processing beam and in particular for regulating the focal position of the processing beam.

10. The monitoring apparatus according to claim 1, wherein the allowed distance value range (Z) is defined as a function of a prevailing processing situation and/or is ascertained by the monitoring apparatus as a function of a prevailing processing situation.

11. The monitoring apparatus according to claim 1, wherein the processing beam optics includes at least one common deflecting device by means of which the measurement beam and the processing beam can be directed at common ambient positions (X).

12. The monitoring apparatus according claim 11, wherein the distance value (d) ascertained by the monitoring apparatus relates to the distance between the common deflecting device and the reflective area (X) of the surroundings.

13. The monitoring apparatus according to claim 1, wherein the evaluation unit is designed to ascertain when the value determined exceeds and/or falls below the allowed distance value range (Z).

14. The monitoring apparatus according to claim 1, wherein the evaluation unit is designed to detect a malfunction with respect to ascertaining the distance value (d).

15. A processing system for processing the workpiece (W) by means of a high-energy processing beam comprising a monitoring apparatus according to claim 1.

16. A method for monitoring a processing system for processing a workpiece (W) by means of a high-energy processing beam, in particular with a monitoring apparatus according to claim 1, comprising the steps:
Supplying a measurement beam;
Input of the measurement beam into a processing beam optics of the processing system;
Controlling the processing beam optics of the processing system to direct the measurement beam at a position (X) in the surroundings;
Detecting a component of the measurement beam reflected by the surroundings;
Determining at least one distance value (d) on the basis of the detected reflected component of the measurement beam wherein the distance value (d) enables a conclusion regarding the distance from the processing beam optics to the area (X) of the surroundings reflecting the measurement beam; and
Evaluating whether the distance value (d) thereby ascertained is within an allowed distance value range (Z).
